(19) United States
(12) Patent Application Publication
(10) Pub. No.: US 2023/0166657 A1
(43) Pub. Date: Jun. 1, 2023

(54) Radar Reflective Vehicle Breakdown Warning Sign

(71) Applicants: YAO-LIN LIU, Zhubei City (TW); Shih-Yung Liu, Zhubei City (TW); Chen-Yi Liu, Zhubei City (TW)

(72) Inventors: YAO-LIN LIU, Zhubei City (TW); Shih-Yung Liu, Zhubei City (TW); Chen-Yi Liu, Zhubei City (TW)

(21) Appl. No.: 17/535,803

(22) Filed: Nov. 26, 2021

(51) Int. Cl. B60Q 7/00; F21S 43/31; F21S 43/14; G08C 17/02; H01Q 15/14

(52) U.S. Cl. CPC B60Q 7/00; F21S 43/31; F21S 43/14; G08C 17/02; H01Q 15/14

(57) ABSTRACT

A radar reflective vehicle breakdown warning sign comprises primarily a body and a projecting lamp, and a remote control for connecting to the body and the projecting lamp. In an interior of the body is disposed a control circuit and a transmission component connected to the control circuit. The transmission component is pivotally connected to a vehicle breakdown warning sign. On the vehicle breakdown warning sign are disposed radar wave reflecting patches which may reflect the radar waves emitted by a vehicle with an autonomous driving function. In an interior of the projecting lamp is disposed a control circuit and a light emitting component connected to the control circuit.

### BACKGROUND OF THE INVENTION

### 1. Field of the Invention

The present invention relates to a radar reflective vehicle breakdown warning sign, and particularly to a radar reflective vehicle breakdown warning sign that a driver may use to display warning and failure messages without having to get off the vehicle for achieving the effect of preventing collision of autonomous and human-driven vehicles approaching from behind and protecting the safety of the driver.

### 2. Description of Related Art

When a vehicle breaks down on the road, the driver would usually park the vehicle on a side of the road, get off the vehicle, take out a vehicle breakdown warning sign from a rear trunk and put it at an appropriate distance from the rear of the vehicle for alerting vehicles approaching from behind to avoid collision. However, it is risky for the driver to get off the vehicle if this happens on a highway or an expressway, where vehicles move at high speed.

With the advance of technology, some modern-day vehicles are equipped with road condition detecting devices, and for some vehicle brands they are included in the standard equipment. A road condition detecting device may detect road conditions ahead when a vehicle is moving and alert the driver when the vehicle is approaching an object within a certain distance to achieve the purpose of safe driving. A radar detecting device, however, is usually more sensitive to moving objects than stationary ones. Therefore, when a vehicle breaks down and is stationary ahead, even if a vehicle breakdown warning sign is placed behind the broken vehicle, a car accident may still happen since the radar detecting device may not be able to detect it and the driver may also fail to notice it if he/she relies too much on the radar detecting device. In view of this, after laborious research and experiments, the applicant has devised a radar reflective vehicle breakdown warning sign that a driver may use to display warning and failure messages without having to get off the vehicle for achieving the effect of preventing collision of autonomous and human-driven vehicles approaching from behind and protecting the safety of the driver.

### SUMMARY OF THE INVENTION

It is a primary objective of the present invention to provide a radar reflective vehicle breakdown warning sign that a driver may use in case of a vehicle breakdown to display warning and failure messages without having to get off the vehicle for achieving the effect of preventing collision of autonomous and human-driven vehicles approaching from behind and protecting the safety of the driver.

A foregoing radar reflective vehicle breakdown warning sign comprises a body and a projecting lamp, and a remote control for connecting to the body and the projecting lamp. In an interior of the body is disposed a control circuit and a transmission component connected to the control circuit. The transmission component is pivotally connected to a vehicle breakdown warning sign. On the vehicle breakdown warning sign are disposed radar wave reflecting patches which may reflect the radar waves emitted by a vehicle with an autonomous driving function, and in an interior of the projecting lamp is disposed a control circuit and a light emitting component connected to the control circuit. The body and the projecting lamp are respectively disposed on an inner edge of a rear trunk cover and on an inner edge of a rear trunk. When a vehicle breaks down, the driver may open its rear trunk without having to get off the vehicle, turn on the transmission component to sway the vehicle breakdown warning sign, and turn on the projecting lamp to illuminate the vehicle breakdown warning sign and the radar wave reflecting patches for facilitating detection by vehicles approaching from behind to achieve the purpose of alerting them and avoiding collision.

A foregoing radar reflective vehicle breakdown warning sign, wherein the transmission component disposed in an interior of the body is a motor.

A foregoing radar reflective vehicle breakdown warning sign, wherein the light emitting component disposed in an interior of the projecting lamp is a high brightness LED.

A foregoing radar reflective vehicle breakdown warning sign, wherein signals are transmitted between the remote control and the control circuits of the body and the projecting lamp via Bluetooth or wireless high frequency.

### BRIEF DESCRIPTION OF THE DRAWINGS

FIG. 1 is a three-dimensional view of a preferred embodiment according to the present invention;

FIG. 2 is a three-dimensional exploded view of a body according to the present invention;

FIG. 3 is a block diagram of control circuits according to the present invention;

FIG. 4 and FIG. 5 are drawings of the present invention when installed on a vehicle;

FIG. 6 is a drawing of the present invention when being used.

### DETAILED DESCRIPTION OF THE PREFERRED EMBODIMENTS

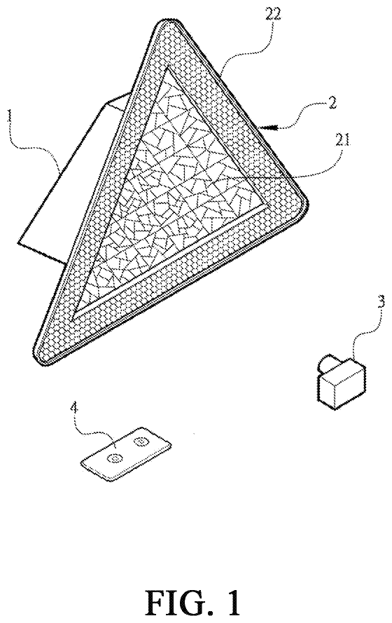

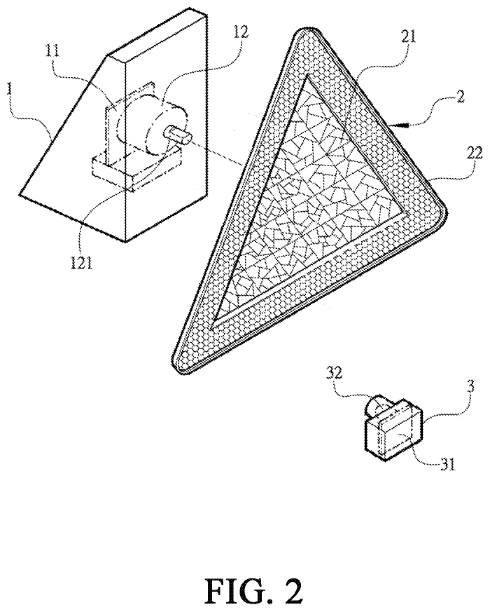

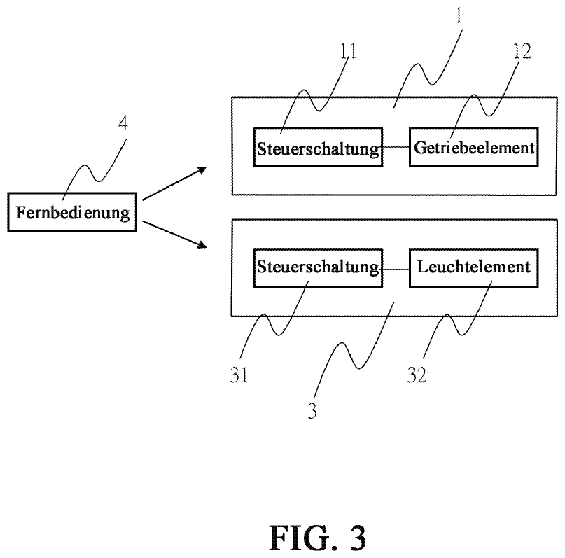

Please refer both to FIG. 1 and FIG. 2, along with FIG. 3, showing respectively a three-dimensional view, a three-dimensional exploded view, and a block diagram of the present invention. As the figures show, the present invention comprises a body 1, a vehicle breakdown warning sign 2, a projecting lamp 3, and a remote control 4 for connecting to the body 1 and projecting lamp 3. In an interior of the body 1 is disposed a control circuit 11 and a transmission component 12 connected to the control circuit. A transmission shaft 121 of the transmission component 12 protrudes from the body 1. In the present embodiment, the transmission component 12 is a motor.

The vehicle breakdown warning sign 2 is pivotally connected to the transmission shaft 121 of the transmission component 12. On a surface of the vehicle breakdown warning sign 2 are disposed a plurality of concave and convex radar wave reflecting patches 21, and at a periphery of the vehicle breakdown warning sign 2 is disposed a wall 22 of an appropriate height.

In an interior of the projecting lamp 3 is disposed a control circuit 31 and a light emitting component 32 connected to the control circuit. In the present embodiment, the light emitting component 32 is a high brightness LED.

The remote control 4 provides connection to the control circuits 11 and 31 of the body 1 and the projecting lamp 3 so that the transmission component 12 and light emitting component 32 may be turned on and off via the control circuits 11 and 31. In the present embodiment, signals are transmitted between the remote control 4 and the control circuits 11 and 31 via Bluetooth or wireless high frequency.

The foregoing components are combined to form a radar reflective vehicle breakdown warning sign. The body 1 and projecting lamp 3 are respectively disposed on an inner edge of a rear trunk cover and on an inner edge of a rear trunk. When a vehicle breaks down, the driver may open its rear trunk without having to get off the vehicle, turn on the transmission component 12 in the body 1 to sway the vehicle breakdown warning sign 2, and turn on the projecting lamp 3 to illuminate the vehicle breakdown warning sign 2 via the light emitting component 32, and further, the radar wave reflecting patches 21 may effectively reflect radar waves for facilitating detection by vehicles approaching from behind to achieve the purpose of alerting them and avoiding collision.

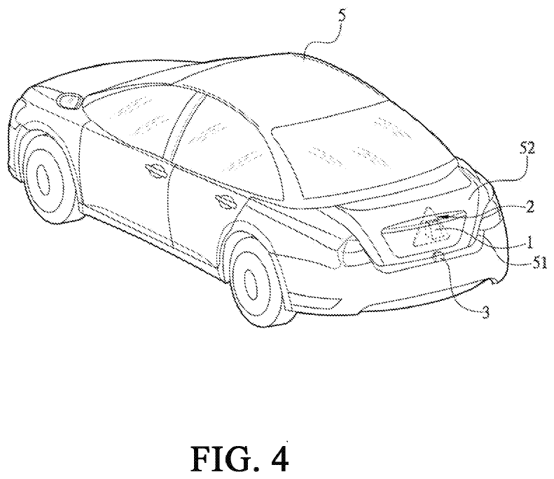

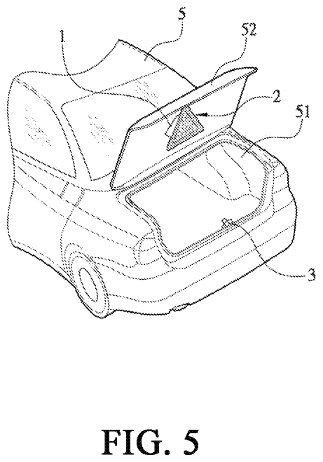

Please refer both to FIG. 4 and FIG. 5, which are drawings of the present invention when installed on a vehicle. As the figures show, when the present invention is being used, a trunk cover 52 of a rear trunk 51 of a vehicle 5 is opened, the body 1 is retained on an inner edge of the trunk cover 52, and the projecting lamp 3 is disposed on an inner edge of the rear trunk 51 with the projecting lamp 3 having a light projection range in correspondence with the vehicle breakdown warning sign 2 on the body 1. When the present invention is not being used, the trunk cover 52 is closed to hide the body 1, the vehicle breakdown warning sign 2 and the projecting lamp 3 in the rear trunk 51.

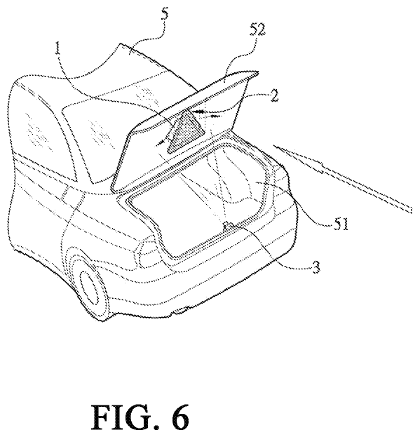

Please refer to FIG. 6, showing a drawing of the present invention when being used. Please also refer to FIGS. 1 to 3. As the figures show, when a vehicle 5 breaks down on the road, the driver may slowly drive the vehicle 5 to park on a side of the road. After making sure it's safe, the driver may open the trunk cover 52 of the rear trunk 51 without having to get off the vehicle 5 to display the vehicle breakdown warning sign 2 on the trunk cover 52 so that vehicles approaching from behind may see the vehicle breakdown warning sign 2 clearly from afar and may promptly react to avoid accidents.

After opening the trunk cover 52, the driver may control the body 1 and projecting lamp 3 via the remote control 4 and turn on the transmission component 12 via the control circuit 11 to sway the vehicle breakdown warning sign 2 and turn on the light emitting component 32 of the projecting lamp 3 via the control circuit 31 to project light on the vehicle breakdown warning sign 2, causing the radar wave reflecting patches 21 to provide a light reflection effect. When a vehicle equipped with a radar detecting device approaches from behind, the radar is sure to detect the swaying vehicle breakdown warning sign 2, effectively protecting the driver particularly at night when vision is impaired. Further, the radar wave reflecting patches 21 disposed on the vehicle breakdown warning sign 2 may surely reflect the radar waves emitted from the vehicle approaching from behind to even better protect the driver.

The foregoing preferred embodiment of the present invention is illustrated of the present invention rather than limiting of the present invention. It is intended to cover various modifications and changes included within the spirit and scope of the appended claims, the scope of which should be accorded the broadest interpretation so as to encompass all such modifications and similar structures.

In view of the foregoing considerations, the present invention relates to a radar reflective vehicle breakdown warning sign comprising a body with a vehicle breakdown warning sign that may sway and a projecting lamp that may project high brightness light. The present invention is provided for being disposed in a rear trunk of a vehicle and is equipped with a remote control for connecting to the body and the projecting lamp. When a vehicle breaks down on the road, the driver may use the present invention to display warning and failure messages without having to get off the vehicle for achieving the effect of preventing collision of autonomous and human-driven vehicles approaching from behind and protecting the safety of the driver.

What is claimed is:

1. A radar reflective vehicle breakdown warning sign comprising:
a body for being disposed on an inner edge of a rear trunk cover of a vehicle, having a control circuit disposed in an interior of the body and a transmission component connected to the control circuit, wherein a transmission shaft of the transmission component protrudes from the body for being pivotally connected to a vehicle breakdown warning sign, and a plurality of concave and convex radar wave reflecting patches are disposed on a surface of the vehicle breakdown warning sign;
a projecting lamp for being disposed on an inner edge of a rear trunk of the vehicle, having a control circuit disposed in an interior of the projecting lamp and a light emitting component connected to the control circuit;
a remote control for connecting to the control circuits of the body and the projecting lamp, wherein via the control circuits the transmission component is driven to sway the vehicle breakdown warning sign and the light emitting component of the projecting lamp is turned on to illuminate the vehicle breakdown warning sign.

2. A radar reflective vehicle breakdown warning sign of claim 1, wherein on a surface of the vehicle breakdown warning sign are disposed radar wave reflecting patches and at a periphery of the vehicle breakdown warning sign is disposed a wall of an appropriate height.

3. A radar reflective vehicle breakdown warning sign of claim 1, wherein the transmission component disposed in an interior of the body is a motor.

4. A radar reflective vehicle breakdown warning sign of claim 1, wherein the light emitting component disposed in an interior of the projecting lamp is a high brightness LED.

5. A radar reflective vehicle breakdown warning sign of claim 1, wherein signals are transmitted between the remote control and the control circuits of the body and the projecting lamp via Bluetooth or wireless high frequency.
